(19) United States
(12) Patent Application Publication
(10) Pub. No.: US 2003/0014362 A1
(43) Pub. Date: Jan. 16, 2003

(54) System for managing inter-company settlement and the method therefor

(76) Inventor: Dong Lyun Yim, Seoul (KR)

Correspondence Address: Jay A Bondell, Schweitzer Cornman Gross & Bondell, 292 Madison Avenue, New York, NY, 10017, US

(21) Appl. No.: 10/203,824

(22) PCT Filed: Feb. 14, 2001
(86) PCT No.: PCT/KR01/00219

(30) Foreign Application Priority Data
Feb. 15, 2000 (KR) 2000/7057
Feb. 12, 2001 (KR) 2001/6687

(51) Int. Cl. G06F 17/60

(52) U.S. Cl. 705/40

(57) ABSTRACT

The present invention relates to a system for managing inter-company settlement and the method therefor. Whenever an event for managing specifics of the purchase price payment or for requesting prepayment of the purchase price, etc., arises in the purchaser's telecommunication client or the seller's telecommunication client, the present invention coordinates the price management server, the authentication module, the module for managing specifics of the purchase price payment, the module for managing recovery of pre-paid money and the account management module to systematically execute the step of managing specifics of the purchase price payment and the step of managing prepayment of the purchase price, etc. Thus, the present invention enables various purchaser and seller companies to form reliable settlement relationships among them, using the on-line network. According to the present invention, the purchase price that a purchaser company must pay is pre-paid through the bank on-line network. As a result, the purchaser company may conveniently build a settlement relationship with the seller company without incurring separate expenses. Ultimately, the present invention greatly increases the reliability of the settlement system among purchaser companies and seller companies and, thus, minimizes economic damage caused by any chain bankruptcy of companies involved.

### TECHNICAL FIELD

The present invention relates to a system for managing inter-company settlement. In particular, the present invention relates to an inter-company settlement management system which enables seller companies and purchaser companies to conduct the sales amount collection procedure and the purchase price payment procedure more reliably by systematically implementing the overall settlement procedures conducted in between purchaser companies and seller companies on the bank on-line networks. Furthermore, the present invention relates to a method for managing inter-company settlement using the said inter-company settlement management system.

### BACKGROUND ART

Recently, corresponding to the rapid economic development, the number of transactions between companies has increased accordingly with an outstanding speed. Under these circumstances, the settlement relation between seller companies and purchaser companies has become an important issue in the society.

The reason that the settlement relation between the seller company and the purchaser company is an important social issue is as follows. If an unreliable settlement system between the seller company and the purchaser company causes individual companies to go bankrupt, the basic economic order of the nation may be destroyed and the entire social order may be adversely affected, rendering a serious problem in the society. In the conventional transaction structure between companies, a seller company, which has provided goods or services, conducts a series of procedures to claim the payment of sales amount against a purchaser company. As the major payment method, most of the purchaser companies have preferred payment by bills to payment in cash because a purchaser company may manage the find more flexibly if the payment is made through bills, compared with the payment in cash.

Because the payment by bills involves complex processes of issuance, collection, etc., both the purchaser company and the seller company that use the payment by bills as the major payment method would have to experience a great inconvenience. Furthermore, because the bills are generally transferred off-line, there is always a risk of theft or loss. Thus, purchaser companies and seller companies that use the bill payment method must take additional precaution measures.

Additionally, the issuance date and the payment date are different in the bill payment method. Thus, a seller company who receives a bill from the purchaser company bears the risk of the purchaser company's failure to actually pay the purchase price. If such risk becomes a reality and the purchaser company which issued bills goes bankrupt without paying the purchase price, the seller company may incur a significant amount of damages.

Here, if such seller company in damage is related to other companies by other settlement relationships, the bankruptcy of one purchaser company may cause chain-bankruptcy of many seller companies. If such problems are not dealt with, a serious social problem may arise, significantly impairing the general economic order of the society.

### DISCLOSURE OF INVENTION

The purpose of the present invention is to enable a purchaser company to establish a settlement system against seller companies without incurring special financial strains, by making on-line prepayments of the purchase price on behalf of the purchaser company based upon the rights to the accounts receivable that the seller company had obtained from the purchaser company and provided as a collateral.

Another purpose of the present invention is to preclude purchaser companies from using the conventional payment method by bills and, thus, to improve the reliability of the settlement system formed between the purchaser companies and seller companies. Consequently, unexpected damage or loss to seller companies may be minimized.

Another purpose of the present invention is to implement the overall settlement procedures conducted between seller companies and purchaser companies systematically on the on-line networks. Through such implementation of the system on the on-line networks, it is intended that the seller companies and the purchaser company may conveniently conduct the sales amount collection procedure and the purchase price payment procedure without bearing unnecessary risks of theft or loss.

Another purpose of the present invention is to improve the reliability of the settlement system between the purchaser company and the relevant seller companies, minimizing the economic loss caused by various companies' chain bankruptcy.

Other purposes of the present invention will become apparent from the following detailed description and the attached drawings.

In order to attain the above-mentioned purposes of the present invention, the present invention implements an inter-company settlement management system comprising a D/B block, a D/B management server and a payment management server. The said D/B block comprises an authentication information database (“D/B”) with a series of authentication information, a purchase price payment statement information D/B with the purchase price payment statement information, a loan prepayment information D/B with a series of loan prepayment information, a credit card purchase price prepayment information D/B with a series of information on the purchase price prepayment by credit card, and a registration information D/B with a series of registration information.

The D/B block stores the said authentication information, purchase price payment statement information, loan prepayment information, credit card purchase price prepayment information or registration information, etc. selectively in the relevant field of the said D/B block, or extracts the said information from the D/B block.

The said payment management server, in a state connected to the said D/B management server for telecommunication, determines whether to store or extract the said authentication information, purchase price payment statement information, loan prepayment information, credit card purchase price prepayment information, etc.

Additionally, if an event for management of the purchase price payment statement and an event of requesting the sales amount prepayment arises in telecommunication clients of a purchaser company and a seller company, the payment management server, in a state interfaced with the said telecommunication clients of the purchaser company and the seller company through the bank on-line network, analyzes the said various information, prepays the purchase price that a relevant purchaser company must pay to the seller company, and collects, on line, the amount equivalent to such pre-paid amount from the purchaser company after a predetermined period of time passes.

### BRIEF DESCRIPTION OF DRAWINGS

FIG. 1 is a diagram illustrating the settlement relations between companies adopting the present invention.

FIG. 2 is a diagram illustrating the inter-company settlement management system according to the present invention.

FIG. 3 is a flow chart illustrating the sequence of the inter-company settlement method according to a preferred embodiment of the present invention.

FIG. 4 and FIG. 5 are diagrams showing the initially displayed pages of the seller company's telecommunication client and the purchaser company's telecommunication client, according to a preferred embodiment of the present invention.

FIG. 6 is a flow chart illustrating the sequence of the inter-company settlement method according to another preferred embodiment of the present invention.

FIG. 7 and FIG. 8 are diagrams showing the messages displayed for the purchaser company's telecommunication client according to another preferred embodiment of the present invention.

FIG. 9 is a flow chart illustrating the sequence of the inter-company settlement method according to still another preferred embodiment of the present invention.

FIG. 10 and FIG. 11 are diagrams showing the messages displayed for the seller company's telecommunication client according to still another preferred embodiment of the present invention.

FIG. 12 is a flow chart illustrating the sequence of the inter-company settlement method according to still another preferred embodiment of the present invention.

FIG. 13a to FIG. 13d are diagrams illustrating the settlement states of the designated accounts of the purchaser company according to still another embodiment of the present invention

### BEST MODE FOR CARRYING OUT THE INVENTION

References will now be made in detail to the preferred implementations of the present invention's inter-company settlement management system and the method therefor using the said system as illustrated in the accompanying drawings.

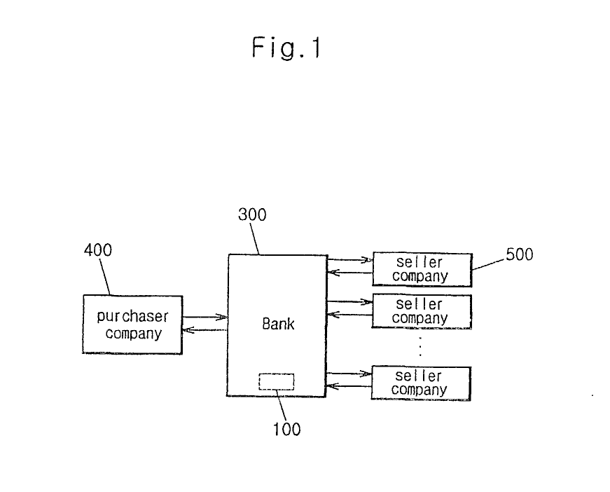

As illustrated in FIG. 1, the inter-company settlement management system (100) according to the present invention is a part of the computer on-line network of a financial institution, for example, a bank (300), which may reliably manage the settlement relations between a purchaser company (400) and multiple seller companies (500).

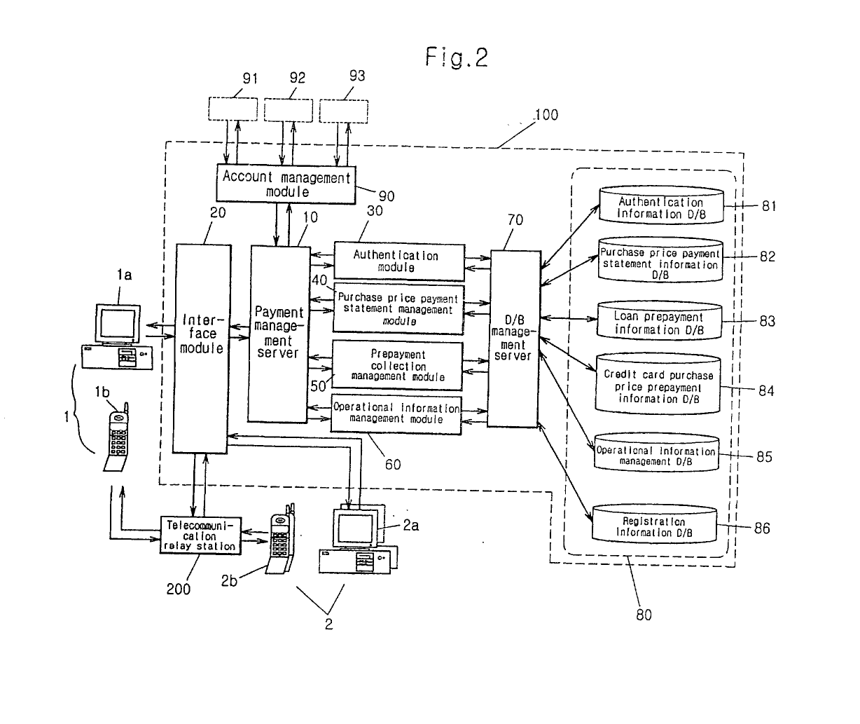

As illustrated in FIG. 2, the present invention's inter-company settlement management system (100) which belongs to the computer on-line network of the bank (300) is composed largely of the DIB block (80), D/B management server (70), and the payment management server (10). In the said D/B block (80) are located an authentication information D/B (81) with a series of authentication information, a purchase price payment statement information D/B (82) with the purchase price payment statement information, a loan prepayment information D/B (83) with a series of loan prepayment information, a credit card purchase price prepayment information D/B (84) with a series of information on the credit card purchase price prepayment, an operational information D/B (85) with a series of operational information and a registration information DIB (86) with a series of registration information regarding the purchaser company (400) and seller companies (500).

The said D/B management server (70) stores the said authentication information, purchase price payment statement information, loan prepayment information, credit card purchase price prepayment information, operational information or registration information selectively in the relevant field of the D/B block (80), or extracts various data from the said authentication information D/B (81), the purchase price payment statement information D/B (82), the loan prepayment information D/B (83), the credit card purchase price prepayment information D/B (84), the operational information D/B (85), or the registration information D/B (86).

Here, the said D/B management server (70) not only stores or extracts various data but also conducts an intelligent function of effectively managing the various data without redundancy within the shortest period of time possible.

As illustrated in the drawing, the said payment management server (10) is interfaced with the telecommunication client (1) of the purchaser company (400) and the telecommunication client (2) of the seller company through a device such as an interface module (20).

More specifically, the telecommunication client (1) of the purchaser company (400), such as the purchaser company's computer (1a) and the purchaser company's wired/wireless telephone (1b), and the telecommunication client (2) of the seller company (500), such as the seller company's computer (2a) and the seller company's wired/wireless telephone (2b), are connected to the present invention's inter-company settlement management system (100) through the bank on-line network such as the wired/wireless Internet, automatic response system communication network, value added network, or public switched telephone network, etc.

In this state, the payment management server (10) systematically controls the D/B management server through the authentication module (30), the purchase price payment statement management module (40), the prepayment collection management module (50) and the operational information management module (60). In this way, the payment management server (10) determines whether to store or extract certain authentication information, purchase price payment statement information, loan prepayment information, credit card purchase price prepayment information, operational information or registration information.

Additionally, if an event of managing the purchase price payment statements or an event of requesting sales amount prepayment occurs from the telecommunication client (1) of the said purchaser company (400) or the telecommunication client (2) of the seller company (500), the payment management server (10) systematically analyzes the said authentication information, purchase price payment statement information, loan prepayment information, credit card purchase price prepayment information, operational information and registration information, and prepays on-line the purchase price that the purchaser company (400) must pay to the seller company (500). After a predetermined period of time passes, the said payment management system (10) collects, on line, the amount equivalent to the relevant prepayment from the purchaser company (400).

The said authentication module (30) authenticates the purchaser company (400) or the seller company (500) which accesses the present invention's inter-company settlement management system (100) through the telecommunication client (1) of the purchaser company (400) or the telecommunication client (2) of the seller company (500). The authentication module (30) conducts said authentication function by checking the registration using the said authentication information Dim (81). The purchase price payment statement management module (40), by using the said purchase price payment statement information D/B (82), manages the purchasing price payment statements that the telecommunication client (1) of the purchaser company (400) transmits.

Furthermore, the prepayment collection management module (50) manages the prepayment made to the seller company, by utilizing the said loan prepayment information D/B (83) and the credit card purchase price prepayment D/B (84). The operational information management module (60), using the said operational information D/B (85) and the registration information D/B (86), manages the detailed operational matters of the payment management server (10).

Here, as illustrated in the drawing, the account management module (90) is closely connected to the payment management server (10) as the said authentication module (30), the purchase price payment statement management module (40), the prepayment collection management module (50), and operational information management module (60) are similarly connected to the payment management server (10). In the state connected for telecommunication with the payment management server (10), the account management server (90) manages the designated account. (92) of the system (100), the designated account (91) of the purchaser company (400), and the designated account (93) of the seller company (500).

Now, the inter-company settlement management method using the above-described inter-company settlement management system (100) according to the present invention will be explained in detail.

First of all, the purchaser company (400), which purchased certain goods or services and the seller company (500) which sold such goods or services access the present invention's inter-company settlement management system (100) through the said telecommunication client (1) of the purchaser company (400), for example, the computer (1a) of the purchaser company, and through the telecommunication client (2) of the seller company (500), for example, the computer (2a) of the seller company. Of course, the purchaser company (400) and the seller company (500) may also use various telecommunication clients other than the computers (1a or 2a). For instance, the wired/wireless communication device (1b) on the purchaser company or the wired/wireless communication device (2b) on the seller company may be selected for access to the inter-company settlement management system (100).

If the purchaser company (400) or the seller company (500) selects the wired/wireless communication device (1b or 2b) for the access to the present invention's system, the telecommunication relay station (200) transmits data from the purchaser company's wired/wireless communication device (1b) or the seller company's wired/wireless communication device (2b) to the interface module (20), and vice versa.

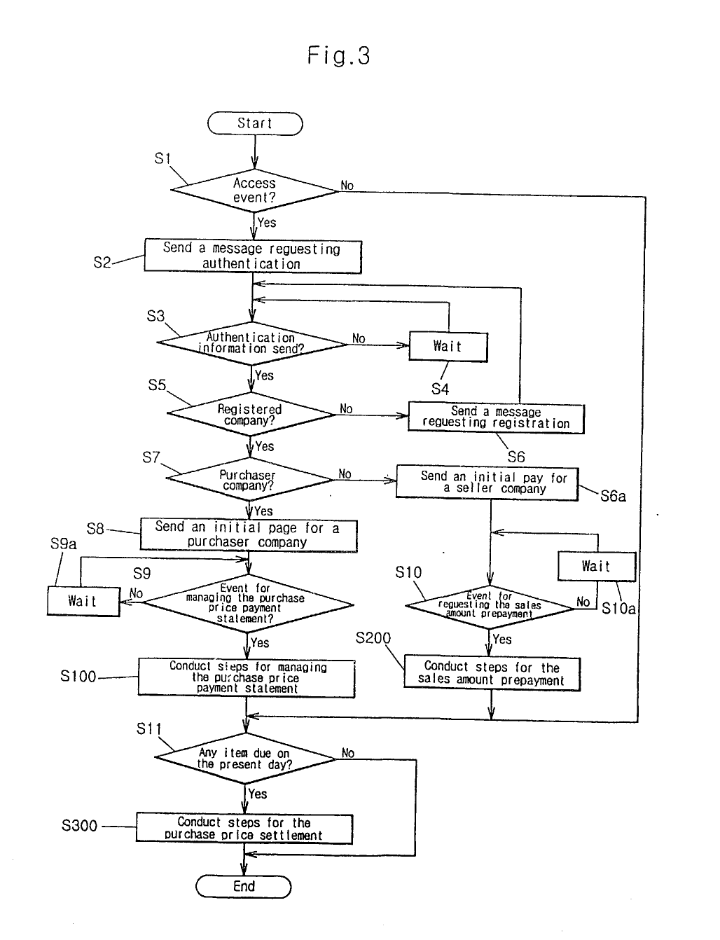

When the said environment is in place, as illustrated in FIG. 3, the payment management server (10) determines whether there is a system access event from the purchaser company's computer (1a) or the seller company's computer (2a) (Step S1).

If there has been no system access event from the purchaser company's computer (1a) or the seller company's computer (2a), the payment management server (10) proceeds to conduct Step S11 as described below.

However, if there is a system access event from either the purchaser company's computer (1a) or the seller company's computer (2a), the payment management server (10) extracts the relevant operational information from the operational information D/B (80) by using the operational information management module (60). Thereafter, using such operational information, the payment management server (10) generates an authentication request message and transmits the generated authentication request message to the relevant computer that has issued the system access event (Step S2).

If the system access event has arisen from the purchaser company's computer (1a), such authentication request message will be transmitted to the purchaser company's computer (1a). In contrast, if the seller company's computer (2a) has issued the system access event, the authentication request message will be transmitted to the seller company's computer (2a).

Then, the relevant computer, for example, the purchaser company's computer (1a) or the seller company's computer (2a), interprets the authentication request message transmitted from the payment management server (10) and displays such message so that the relevant purchaser company (400) or the seller company (500) may obtain the authentication expeditiously.

The payment management server (10) continuously checks with the interface module (20) to determine whether the purchaser company's computer (1a) or the seller company's computer (2a) has transmitted the requested authentication information (Step S3).

If it is determined that the purchaser company's computer (1a) or the seller company's computer (2a) has not transmitted authentication information, the payment management server (10) considers that the relevant computer has not yet completed the input of the authentication information and goes to Step S4 to wait for the authentication information.

In contrast, if it is determined that the purchaser company's computer (1a) or the seller company's computer (2a) has transmitted authentication information, the payment management server (10) immediately contacts the authentication module (30) to determine whether the purchaser company (400) or the seller company (500) which is presently connected to the system (100) through the relevant purchaser company's computer (1a) or the seller company's computer (2a) has been registered with the system (Step S5).

Here, in order to be authenticated as a registered company, the purchaser company (400) must have executed a separate purchaser company agreement with the bank (300). Such agreement may be, for example, a specific agreement or a credit card issuance agreement. Furthermore, the information regarding such agreement must have been recorded in the authentication information D/B (81). In order for the seller company (500) to be authenticated as a registered company, such seller company (500) must have executed a separate seller company agreement with the bank (300), which agreement being, for example, a loan agreement or an agreement for a credit card member company. The relevant information also must have been recorded in the authentication information D/B (81). Any purchaser company (400) or seller company (500) which fails to satisfy the above-described conditions, may not be authenticated as a registered company and, thus, may not enjoy the services available through the present invention.

If it is determined that the company accessing the system (100) is not a registered company, the payment management server (10) generates a registration request message and transmits such registration request message to the computer of the relevant company (Step S6). Such message may state, for example, “You are not a registered client. Please register first.”

In contrast, if the company accessing the system (100) is determined to be a registered company, the payment management server (10), using the operational information management module (60), collects the relevant registration information regarding the company from the registration information D/B (86) and then determines whether the connected company is the purchaser company (400) or the seller company (500) (Step S7).

If the company is determined to be a purchaser company (400), the payment management server (10) generates an initial page for a purchaser company reflecting the relevant purchaser company's registration information. When such initial page is completed, the payment management server (10) transmits the initial page to the purchaser company's computer (Step S8).

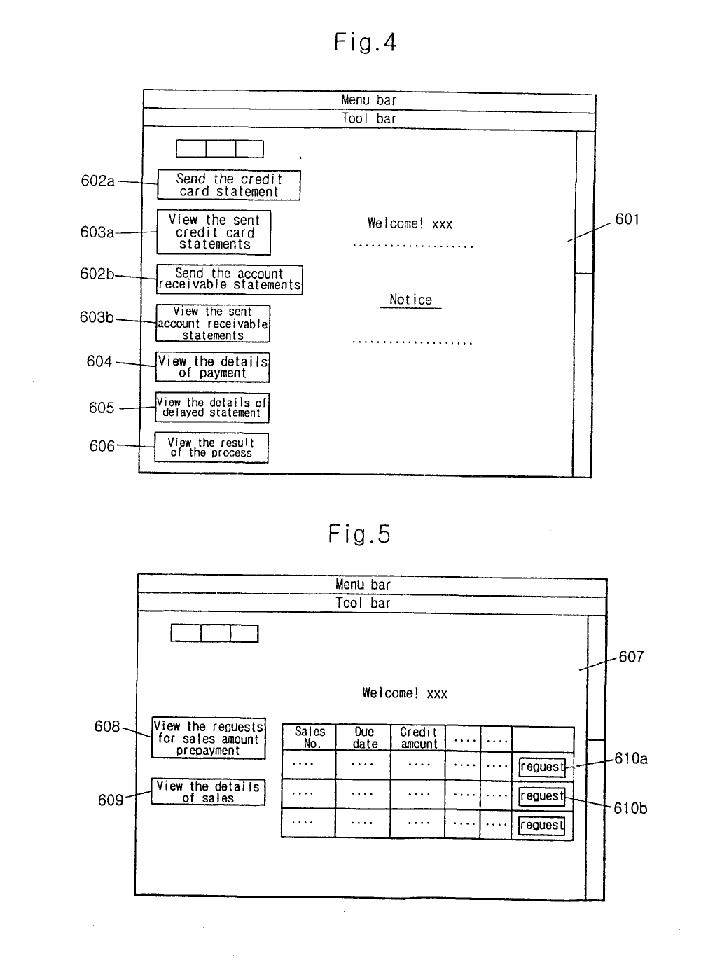

The purchaser company's computer (1a) then immediately interprets the transmitted initial page (601) and displays the page as illustrated in FIG. 4, enabling the purchaser company to conveniently conduct the management of the purchase price payment statement.

If the company accessing the system (100) is determined to be a seller company (500), the payment management server (10) generates an initial page for a seller company reflecting the relevant seller company's registration information. When such initial page is completed, the payment management server (10) transmits the initial page to the seller company's computer (2a) (Step S6a).

In such an event, the seller company's computer (2a) immediately interprets the said initial page designed for a seller company and displays the page as illustrated in FIG. 5. Thus, the seller company (500) may conveniently conduct the steps of requesting the prepayment of the sales amount.

Here, the purchase price payment statement means the statement setting forth the payments that the purchaser company (400) made to the seller company (500) for the purchased goods or services. If the purchaser company (400) transmits an “accounts receivable statement” as a purchase price payment statement, this means that the purchase price has been paid through the accounts receivable. If the purchaser company (400) transmits a “credit card statement” as a purchase price payment statement, this means that the purchase price has been paid by the company credit card. The said company credit card is a special card that the bank (300) using the present invention's settlement management system (100) issues to the purchaser company (400) which has entered into a “credit card issuance agreement.”

As illustrated in FIG. 4, the initial page (601) of the purchaser company's computer (1a) contains the following items: “send the credit card statement” (602a); “view the sent credit card statements” (603a); “send the account receivable statement” (602b); “view the sent account receivable statements” (603b); “view the details of payment” (604); “view the details of delayed payment” (605); and “view the result of the process” (606). The purchaser company (400) may confirm or set any of the said items real time by clicking the relevant item on the page. The said items may be modified in accordance with the changing circumstances.

As illustrated in FIG. 5, the initial page (607) of the seller company's computer (2a) contains the following items: “view the requests for sales amount prepayment” (608); “view the details of sales” (609); “request for loan” (610a); and “request for credit card purchase” (610b). The seller company (500) may confirm or set any of the said items real time by clicking the relevant item on the page. Of course, the said items may also be modified in accordance with the changing circumstances.

For instance, the seller company (500) may generate information regarding the request of loan by selecting the item, request for loan (610a). The information regarding the request of loan here means the information to request the sales amount prepayment, that the seller company (500), which has sold certain goods or provided certain services, sends to the bank (300) associated with the purchaser company (400) which “pays the purchase price for the goods or services through the accounts receivable.” The present invention's system (100) prepays the requested ioan amount on behalf of the purchaser company (400) based upon the said “information regarding the request of loan.” Consequently, the seller company (500) may collect, in advance, the sales amount for the goods and services provided by the seller company.

Furthermore, the seller company (500) may select the item, request for credit card purchase (610b), and generates the information on the request for purchase by the credit card. In this case, the information on the request for credit card purchase means the information to request the sales amount prepayment, that the seller company (500), which has sold certain goods or provided certain services, sent to the bank (300) associated with the purchaser company (400) which “pays the purchase price for the goods or services using the company's credit card.” The present invention's system (100) prepays the credit card purchase price on behalf of the purchaser company (400) based upon the said “information on the request for the credit card purchase.” Consequently, the seller company (500) may collect, in advance, the sales amount for the goods and services provided by the seller company.

On the other hand, in the state where the initial page (601) for the purchaser company is displayed on the purchaser's computer (1a), the payment management server (10) determines whether any event for managing the purchase price payment statement has occurred in the said purchaser company's computer (1a) (Step S9).

If it is determined that there has been no event for managing the purchase price payment statement from the purchaser company's computer (1a), the payment management server (10) moves to Step S9a and maintains the “wait” state.

In contrast, if the purchaser company (400) clicks the item, “send the account receivable statement” (602b) or “send the credit card statement” (602a) and, thus, there occurs an event for managing the purchase price payment statements from the purchaser company's computer (1a), the payment management server (10) refers to the purchase price payment statement information transmitted from the purchaser company's computer (1a) and proceeds quickly to conduct the purchase price payment statement management (Step S100).

Similarly, the payment management server, in the state where the initial page for a seller company (607) is displayed on the seller company's computer (2a), determines whether there has been an event for requesting the sales amount prepayment from the said seller company's computer (2a) (Step S10).

Here, if it is determined that there has been no event for requesting the sales amount prepayment from the seller company's computer (2a), the payment management server (10) moves the flow to Step S10a and maintains the “Wait” state.

In contrast, if the seller company (500), clicks the item, “request for loan” (610a) or “request for credit card purchase” (610b), and, thus, there occurs an event for requesting the sales amount prepayment from the seller company's computer (2a), the payment management server (10) refers to the sales amount prepayment information transmitted from the seller company's computer (2a) and proceeds quickly to conduct the sales amount prepayment (Step 200).

First, the said step for managing the purchase price payment statements (Step S100) will be explained in detail.

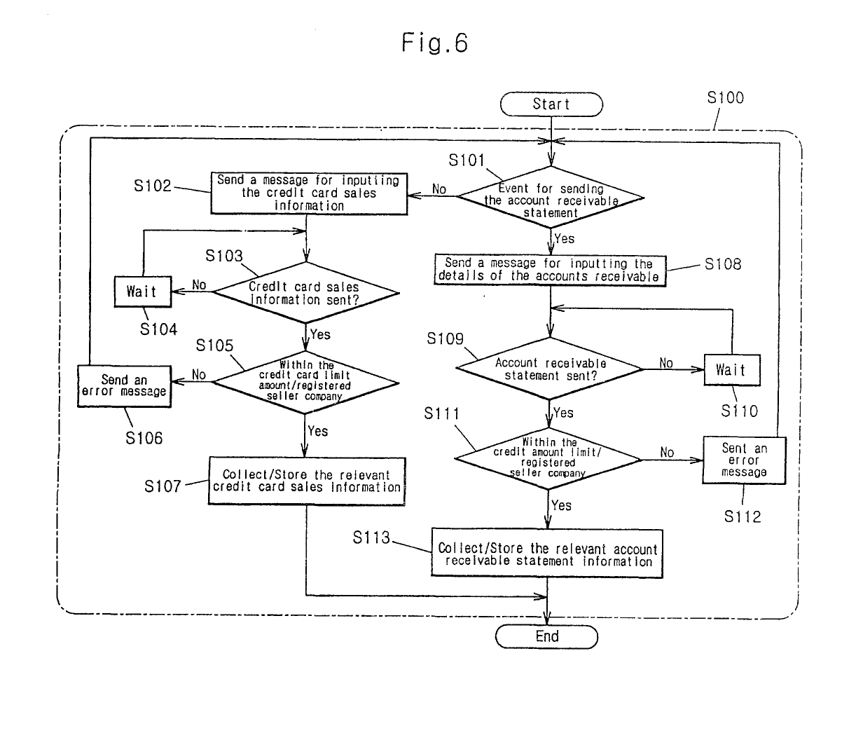

As illustrated in FIG. 6, the payment management server (10) determines whether there has been any event for sending the account receivable statement from the purchaser company's computer (1a) (Step S101).

At this time, if the purchaser company (400) clicks the item “send the credit card statement” (602a) on the initial page (601) and accordingly if it is determined that an event for sending the credit card statement has occurred instead of an event for sending the account receivable statement, the payment management server (10) uses the operational information management module (60) to generate the message for inputting the details regarding the credit card purchase. When the page is completed, the payment management server sends the completed page for inputting the details regarding the credit card purchase to the purchaser company's computer (1a) through the interface module (20) (Step S102).

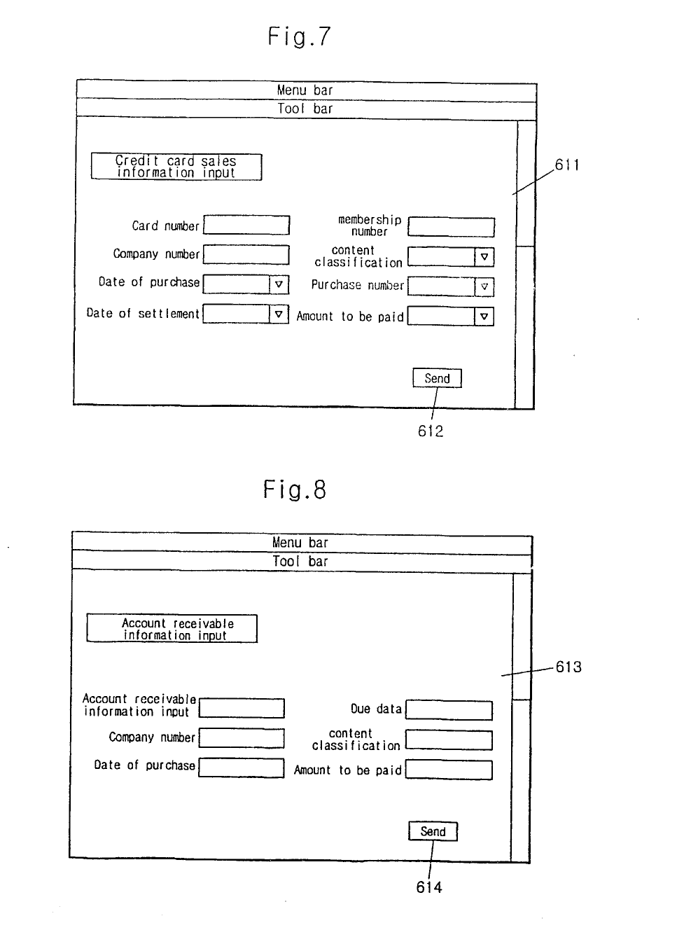

The purchaser company's computer (1a) then quickly interprets the message for inputting the details regarding the credit card purchase (611) and displays it as illustrated in FIG. 7, providing the stable environment in which the purchaser company (400) may create the information regarding the credit card purchase.

At this stage, the payment management server (10) continually checks with the interface module (20) and determines whether the purchaser company's computer (1a) has transmitted the information on the credit card purchase (Step S103).

If the purchaser company (400) has not yet inputted the details regarding the credit card purchase and thus if the information on the credit card purchase has not yet been transmitted from the purchaser company's computer (1a), the payment management server (10) moves to Step S104 and maintains the waiting state.

In contrast, if the purchaser company (400) completed the input of the details regarding the credit card purchase and clicked the item “send” (612) and, thus, it is determined that the purchaser company's computer (1a) has transmitted the information on the credit card purchase, the payment management server (10) determines whether the said information on the credit card purchase is acceptable. For instance, it is determined whether the amount recorded in the said information as the amount to be paid is within the limit of the credit amount and whether the seller company recorded in the said information as the company to be paid is a registered seller company, etc. (Step S105).

Here, if the amount recorded in the said information exceeds the limit of the credit amount or if the seller company recorded as the company to be paid is not a registered seller company, the payment management server (10) proceeds to conduct a step to send an error message to the purchaser company's computer (1a) (Step S106).

In such an event, the payment management server (10) uses the operational information management module (60) to extract certain operational information which has been stored in the operational information D/B (85). Then, the payment management server (10), using such operational information, generates an error message such as “The amount inputted exceeds the limit of your credit amount. Please try again.” The generated error message is transmitted to the purchaser company's computer (1a).

In contrast, if the amount recorded in the information on the credit card purchase does not exceed the pre-designated credit limit of the credit card and if the seller company recorded as the company to be paid is determined to be a registered seller company, the said information on the credit card purchase is deemed acceptable. Accordingly, the payment management server (10) proceeds to collect and store the said information on the credit card purchase (Step S107).

The payment management server (10) transmits the information on the credit card purchase, which has been transmitted from the purchaser company's computer (1a), to the purchase price payment statement management module (40). The purchase price payment statement management module (40), immediately upon receiving the information on the credit card purchase, transmits the said information to the D/B management server (70). In this manner, the information on the credit card purchase is collected and stored in the purchase price payment statement information D/B (82).

On the other hand, in the said Step S101, if the purchaser company (400) clicks the item “send the account receivable statement” (602b) on the initial page (601) and if it is accordingly determined that an event for sending the account receivable statement has occurred, the payment management server (10) uses the operational information management module (60) to generate the message for inputting the details of the relevant accounts receivable. The payment management server (10) then transmits the completed message for inputting the details of accounts receivable to the purchaser company's computer (1a) through the interface module (20) (Step S108).

In this event, the purchaser company's computer (1a) quickly interprets the message for inputting the details of accounts receivable (613), which has been sent by the payment management server (10), and then displays the message as illustrated in FIG. 8, providing the stable environment in which the purchaser company (400) may create the information on the account receivable statement.

At this stage, the payment management server (10) continually checks with the interface module (20) and determines whether the purchaser company's computer (1a) has transmitted the information on the account receivable statement (Step S109).

If the purchaser company (400) has not yet inputted the details regarding the accounts receivable and thus if the information on the account receivable statement has not yet been transmitted from the purchaser company's computer (1a), the payment management server (10) moves to Step S10 and maintains the waiting state.

In contrast, if the purchaser company (400) completed the input of the details regarding the accounts receivable and clicked the item “send” (614) and, thus, it is determined that the purchaser company's computer (1a) has transmitted the information on the account receivable statement, the payment management server (10) determines whether the said information on the account receivable statement is acceptable. For instance, it is determined whether the amount recorded in the said information as the amount to be paid is within the predetermined limit of the account receivable amount and whether the seller company recorded in the said information as the company to be paid is a registered seller company, etc. (Step S111).

Here, if the amount recorded in the said information exceeds the limit of the account receivable amount or if the seller company recorded as the company to be paid is not a registered seller company, the payment management server (10) proceeds to conduct a step to send an error message to the purchaser company's computer (1a) (Step S112).

In such an event, the payment management server (10) uses the operational information management module (60) to extract certain operational information which has been stored in the operational information D/B (85). Then, the payment management server (10), using such operational information, generates an error message such as “The amount inputted exceeds the limit of account receivable amount. Please try again.” The generated error message is transmitted to the purchaser company's computer (1a)

In contrast, if the amount recorded in the information on the account receivable statement does not exceed the pre-designated limit of the account receivable amount and if the seller company recorded as the company to be paid is determined to be a registered seller company, the said information on the account receivable statement is deemed acceptable. Accordingly, the payment management server (10) proceeds to collect and store the said information on the account receivable statement (Step S113).

The payment management server (10) transmits the information on the account receivable statement, which has been transmitted from the purchaser company's computer (1a), to the purchase price payment statement management module (40). The purchase price payment statement management module (40), immediately upon receiving the information on the account receivable statement, transmits the said information to the D/B management server (70). In this manner, the information on the account receivable statement is collected and stored in the purchase price payment statement information D/B (82).

Now, the said step of the purchase price prepayment (Step S200) will be explained in detail.

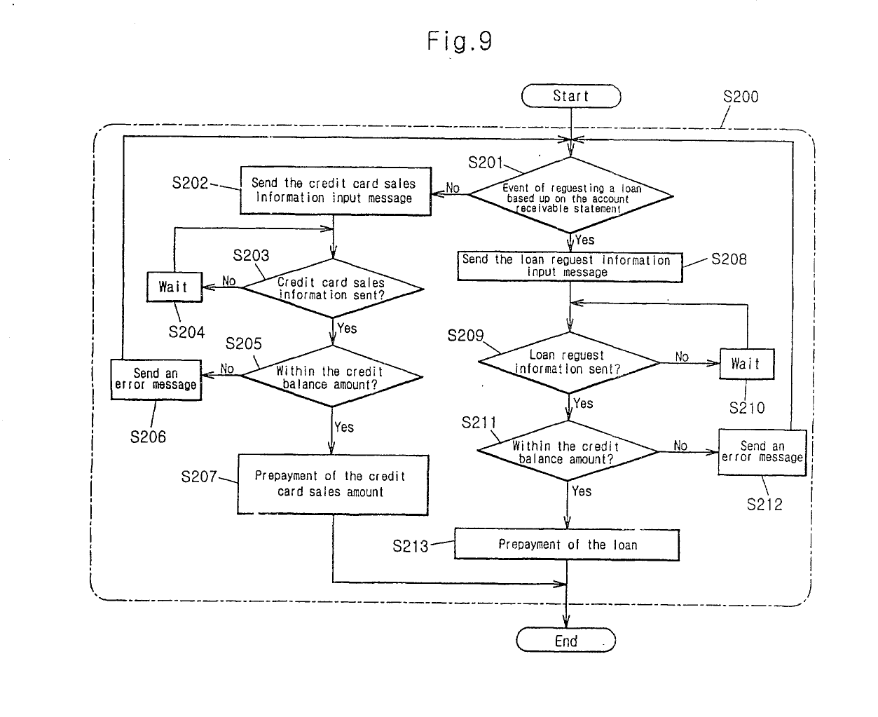

First, as illustrated in FIG. 9, the payment management server (10), by continually checking with the interface module (20), determines whether there has occurred an event for requesting a loan based upon the account receivable statement from the seller company's computer (2a) (Step S201).

At this time, if the seller company (500) clicks the item “request for the credit card purchase (request for the payment of the credit card sales amount)” (610b) on the initial page (607) and accordingly if it is determined that an event for payment of the credit card sales amount has occurred from the seller company's computer (2a) instead of an event for requesting a loan based upon the account receivable statement, the payment management server (10) uses the operational information management module (60) to generate the message for inputting the details regarding the credit card sales. When the page is completed, the payment management server sends the completed page for inputting the details regarding the credit card sales to the seller company's computer (2a) through the interface module (20) (Step S202).

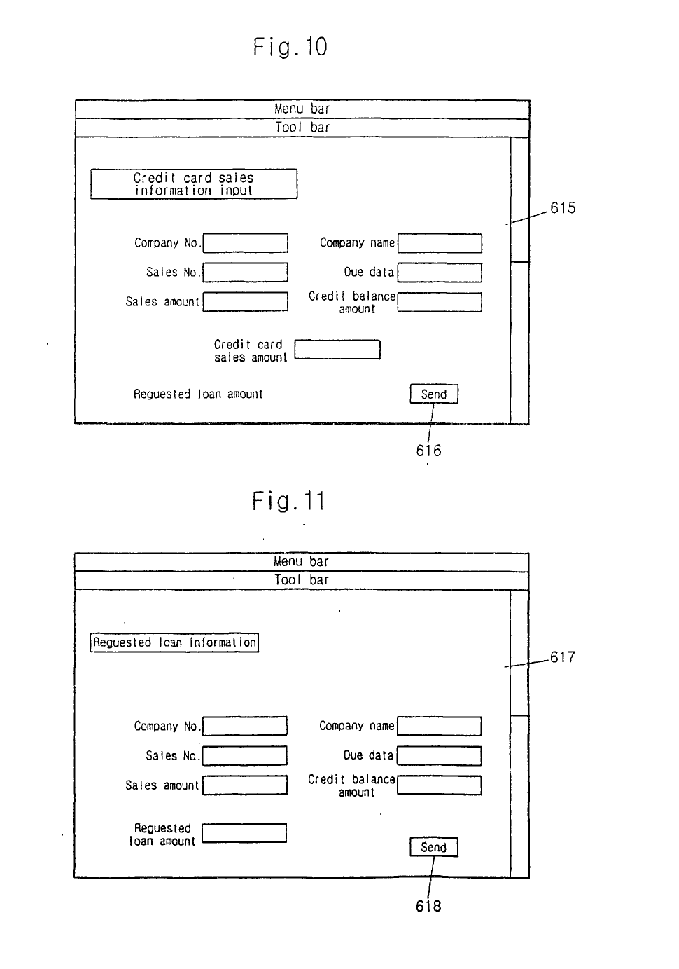

The seller company's computer (2a) then quickly interprets the message for inputting the details regarding the credit card sales (615) and displays it as illustrated in FIG. 10, providing the stable environment in which the seller company (400) may create the information regarding the credit card sales.

At this stage, the payment management server (10) continually checks with the interface module (20) and determines whether the seller company's computer (2a) has transmitted the information on the credit card sales (Step S203).

If the seller company (500) has not yet inputted the details regarding the credit card sales and thus if the information on the credit card sales has not yet been transmitted from the seller company's computer (2a), the payment management server (10) moves to Step S204 and maintains the waiting state.

In contrast, if the seller company (500) completed the input of the details regarding the credit card sales and clicked the item “send” (616) and, thus, it is determined that the seller company's computer (2a) has transmitted the information on the credit card sales, the payment management server (10) determines whether the amount recorded in the said information on the credit card sales as the amount to be paid does not exceed the balance of the predetermined credit limit amount. (Step S205).

Here, if the amount recorded in the said information exceeds the balance of the credit limit amount, the payment management server (10) proceeds to conduct a step to send an error message to the seller company's computer (2a) (Step S206).

In such an event, the payment management server (10) uses the operational information management module (60) to extract certain operational information which has been stored in the operational information D/B (85). Then, the payment management server (10), using such operational information, generates an error message such as “The amount inputted exceeds the balance of the credit limit amount. Please try again.” The generated error message is transmitted to the seller company's computer (2a).

In contrast, if the amount recorded in the information on the credit card sales does not exceed the balance of the credit amount limit, the payment management server (10) proceeds to make the prepayment of the “credit card sales amount” to the seller company (500) on behalf of the purchaser company (400) (Step S207).

In such an event, the payment management server (10) instructs the account management module (90) to make the prepayment of the “credit card sales amount.” The account management module (90), immediately upon receiving such instruction, transfers the specified amount of cash from the designated account of the system (92) to the designated account of the seller company (93). Accordingly, the seller company (500) which has sold goods or provided services to the purchaser company (400) may receive, on line, the prepayment of the “credit card sales amount” for “the provided goods or services” conveniently.

On the other hand, in the said Step S201, if the seller company (500) clicks the item “request for a loan” (610a) on the initial page (607) and if it is accordingly determined that there has occurred an event for requesting a loan based upon the account receivable statement from the seller company's computer (2a), the payment management server (10) uses the operational information management module (60) to generate the message for inputting the details of the loan request. The payment management server (10) then transmits the completed message for inputting the details of the loan request to the seller company's computer (2a) through the interface module (20) (Step S208).

In this event, the seller company's computer (2a) quickly interprets the message for inputting the details of the loan request (617) which has been transmitted from the payment management server (10) and displays the message as illustrated in FIG. 11, providing the stable environment in which the seller company (500) may expeditiously proceed with the loan request.

At this stage, the payment management server (10) continually checks with the interface module (20) and determines whether the seller company's computer (2a) has transmitted the information on the loan request (Step S209).

If the seller company (500) has not yet inputted the details regarding the loan request and thus if the information on the loan request has not yet been transmitted from the seller company's computer (2a), the payment management server (10) moves to Step S210 and maintains the waiting state.

In contrast, if the seller company (500) completed the input of the details regarding the loan request and clicked the item “send” and, thus, it is determined that the seller company's computer (2a) has transmitted the information on the loan request, the payment management server (10) determines whether the amount recorded in the said information as the amount to be loaned is within the predetermined limit of the credit balance amount. (Step S211).

Here, if the requested loan amount recorded in the said information exceeds the pre-determined limit of the credit balance amount, the payment management server (10) proceeds to conduct a step to send an error message to the seller company's computer (2a) (Step S212).

In such an event, the payment management server (10) uses the operational information management module (60) to extract certain operational information which has been stored in the operational information D/B (85). Then, the payment management server (10), using such operational information, generates an error message such as “The amount inputted exceeds the limit of the credit balance amount. Please try again.” The generated error message is transmitted to the seller company's computer (2a).

In contrast, if the requested loan amount recorded in the information on the loan request does not exceed the pre-designated limit of the credit amount, the payment management server (10) proceeds to make the prepayment of the “loan amount” to the seller company (500) on behalf of the purchaser company (400) (Step S213).

In such an event, the payment management server (10) instructs the account management module (90) to make the prepayment of the “loan amount.” The account management module (90), immediately upon receiving such instruction, transfers the specified amount of cash from the designated account of the system (92) to the designated account of the seller company (93). Accordingly, the seller company (500) which has sold goods or provided services to the purchaser company (400) may receive, on line, the prepayment of the “loan sales amount” for “the provided goods or services” conveniently.

On the other hand, as illustrated in FIG. 3, when the said step for prepayment of the sales amount (Step S200) is completed, the payment management server (10) uses the purchase price payment statement management module (40) to extract the purchase price payment statement information which was stored in the purchase price payment statement information D/B (82). The payment management server (10) then reviews the said purchase price payment statement information to determine whether the purchase price payment statement contains any item that is due on the present day (Step 11).

If the purchase price payment statement has any item that is due on the present day, the payment management server (10) checks with the designated account (91) of the purchaser company (400) to quickly pay the relevant purchase price of the purchaser company (Step S300).

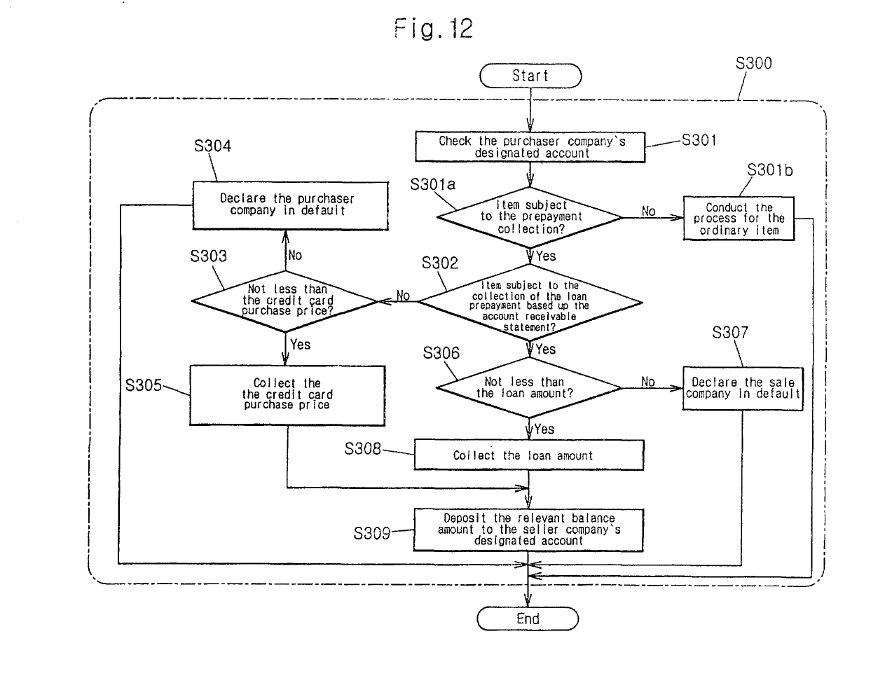

First, as illustrated in FIG. 12, the payment management server (10) controls the account management module (90) and analyzes in detail the designated account (91) of the purchaser company (90) which has issued the purchase price payment statement that is due op the present day (Step S301).

The payment management server (10) then proceeds to determine whether the item due on the present day is subject to the “collection for the prepayment,” a process in which the prepayment, which was made in accordance with the said steps S207 and S213, is to be collected (Step S301a).

Here, if the relevant seller company (500) related to the item due on the present day is an ordinary seller company (500) which did not proceed to “request the sales amount prepayment” and thus it is determined that the item due on the present day is not subject to the “collection of the prepayment” but is subject to the “ordinary process,” the payment management server (10) immediately proceeds to conduct the “ordinary process“(Step S301b). Persons skilled in the relevant art may easily understand the ordinary process for payment. Therefore, we omitted the detailed illustration of the S ordinary process in FIG. 12.

First, the payment management server (10) determines whether the said item subject to the ordinary process is the item under the account receivable statement.

If the said item subject to the ordinary process is determined not to be an item under the account receivable statement, the payment management server (10) deems that the said item subject to the ordinary process is an item under the credit card purchase statement. Then, the payment management server (10) checks whether the amount deposited in the designated account (91) of the purchaser company is not less than the “credit card purchase amount.”

If the amount deposited in the designated account (91) of the purchaser company is less than the “credit card purchase amount,” the payment management server (10) holds the purchaser company (400) which is the credit card debtor of the bank (300) in default. At the same time, on behalf of the purchaser company, the payment management server (10) pays to the seller company (500) the “credit card purchase amount” to which the seller company (500) is entitled to.

In contrast, if it is determined that the amount deposited in the designated account (91) of the purchaser company is equal to or greater than the “credit card purchase amount,” the payment management server (10) transfer the relevant amount from the purchaser company's designated account (91) to the seller company (500)'s designated account (93). Consequently, the seller company (500) receives the sales amount for the goods or services it has provided.

On the other hand, if the item subject to the ordinary process is determined to be an item under the “account receivable statement,” the payment management server (10) checks whether the amount deposited in the purchaser company's designated account (91) is not less than the “amount on the account receivable statement.”

Here, if the amount deposited in the purchaser company's designated account (91) is less than the “amount on the account receivable statement,” the payment management server (10) terminates the flow of process.

In contrast, if the amount deposited in the purchaser company's designated account (91) is equal to or greater than the “amount on the account receivable statement,” the payment management server (10) transfers the relevant amount from the purchaser company's designated account (91) to the seller company (500)'s designated account (93). Thus, the seller company (500) receives the sales amount for the goods or services it has provided.

In the said step S301a, if the item that is due on the present day is determined to be an item subject to the collection of the prepayment, the payment management server (10) determines whether the said item subject to the collection of the prepayment will be collected from the purchaser company (400) for the “loan prepayment” conducted in the said step S213 (Step S302).

If it is determined that the item due on the present day is not the “item for the collection of the loan prepayment,” the payment management server (10) deems that the “item subject to the collection of the prepayment” will be collected from the purchaser company (400) for the “amount of the credit card purchase prepayment” conducted in the said step S207. Thus, the payment management server (10) extracts the credit card purchase price prepayment information through the prepayment collection management module (50). Then, using the said credit card purchase price prepayment information, the payment management server determines whether the amount deposited in the purchaser company's designated account (91) is not less than the “amount of the credit card purchase prepayment” (Step S303).

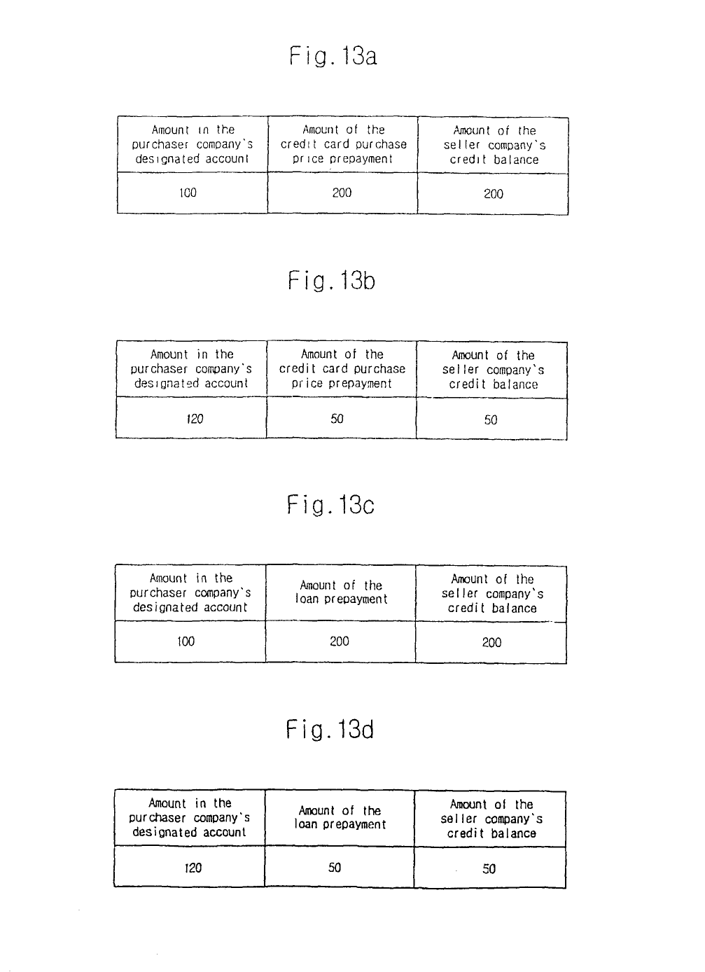

Here, as illustrated in FIG. 13a, if the amount of the credit card purchase prepayment is 200 and the amount deposited in the purchaser company's designated account (91) is 100, which is less than the “amount of the credit card purchase prepayment,” and thus it is determined that the amount deposited in the purchaser company's designated account (91) is less than the “amount of the credit card purchase prepayment,” the payment management server (10) collects the amount 100 deposited in the purchaser company's designated account (91) and, at the same time, holds the relevant purchaser company (400) which is a debtor to the bank (300) in default for the difference of the said amounts, 100 (Step S304).

In this case, the payment management server (10) transmits to the operational module (60) the message which reads “Hold the purchaser company (400) in default.” The operational module, immediately upon receiving the said message, changes the registration information regarding the said purchaser company, which has been stored in the registration information D/B (86). Thereafter, the said purchaser company (400) is characterized and managed as a company in default.

In contrast, as illustrated in FIG. 13b, if the amount of the credit card purchaser prepayment is 50 and the amount deposited in the purchaser company's designated account (91) is 120, and thus it is determined that the amount deposited in the purchaser company's designated account (91) is greater than the “amount of the credit card purchase prepayment,” the payment management server (10) proceeds to conduct the collection of the “amount of the credit card purchase prepayment” which was made by the bank (300) (Step S305).

In this case, the payment management server (10) instructs the account management module (90) to collect the relevant amount from the amount deposited in the purchaser company's designated account (91). Immediately upon the occurring of the said instruction event, the account management module (90) transfers the relevant amount (for example, 50 out of 120) from the purchaser company's designated account (91) to the system's designated account (92). Consequently, the bank (300) may conveniently collect the amount prepaid in the “step of the credit card purchase prepayment.”

Once the collection of the “amount of the credit card purchase prepayment” is completed through the above-described steps, the payment management server (10) proceeds to conduct the step to transfer, from the purchaser company's fund to the seller company's designated account (93), the balance of the sales amount to be paid to the seller company after subtracting the said “amount of the credit card purchase prepayment” (Step S309).

In such an event, the payment management server (10) instructs the account management module (90) to transfer the said relevant balance amount from the purchaser company's designated account (91). Immediately upon the occurring of the said instruction event, the account management module (90) transfers the “balance of the seller company (500)'s sales amount,” 50 in this case, from the purchaser company (400)'s designated account (91) with the remaining fund 70 to the seller company's designated account (93). Consequently, the seller company (500) receives the entire sales amount for the goods or services it has provided.

In contrast, in the said step S302, if the “item subject to the collection of the prepayment” is determined to be an “item subject to the collection of the loan prepayment based upon the account receivable statement,” the payment management server (10) extracts the loan prepayment information through the prepayment collection management module (50). Then, using the said loan prepayment information, the payment management server (10) determines whether the amount deposited in the purchaser company's designated account (91) is not less than the amount of the loan prepayment (Step S306).

Here, as illustrated in FIG. 13c, if the amount of the loan prepayment is 200 and the amount deposited in the purchaser company's designated account (91) is 100, and thus it is determined that the amount deposited in the purchaser company's designated account (91) is less than the “amount of the loan prepayment,” the payment management server (10) collects the amount 100 deposited in the purchaser company's designated account (91) and, at the same time, holds the relevant seller company (500) which is a debtor to the bank (300) in default for the difference of the said amounts, 100 (Step S307).

In this case, the payment management server (10) transmits to the operational module (60) the message which reads “Hold the seller company (400) in default.” The operational module, immediately upon receiving the said message, changes the registration information regarding the said seller company (500), which has been stored in the registration information D/B (86). Thereafter, the said seller company (500) is characterized and managed as a company in default.

In contrast, as illustrated in FIG. 13d, if the amount of the loan prepayment is 50 and the amount deposited in the purchaser company's designated account (91) is 120, and thus it is determined that the amount deposited in the purchaser company's designated account (91) is greater than the “amount of the loan prepayment,” the payment management server (10) proceeds to conduct the collection of the “amount of the loan prepayment” which was made by the bank (300) (Step S308).

In this case, the payment management server (10) instructs the account management module (90) to collect the relevant amount from the amount deposited in the purchaser company's designated account (91). Immediately upon the occurring of the said instruction event, the account management module (90) transfers the relevant amount (for example, 50 out of 120) from the purchaser company's designated account (91) to the system's designated account (92). Consequently, the bank (300) may conveniently collect the amount prepaid in the “step of the loan prepayment.”

Once the collection of the “amount of the loan prepayment” is completed through the above-described steps, the payment management server (10) proceeds to conduct the step to transfer, from the purchaser company's fund to the seller company's designated account (93), the balance of the sales amount to be paid to the seller company after subtracting the said “amount of the loan prepayment” (Step S309).

In such an event, the payment management server (10) instructs the account management module (90) to transfer the said relevant balance amount from the purchaser company's designated account (91). Immediately upon the occurring of the said instruction event, the account management module (90) transfers the “balance of the seller company (500)'s sales amount,” 50 in this case, from the purchaser company (400)'s designated account (91) with the remaining find 70 to the seller company's designated account (93). Consequently, the seller company (500) receives the entire sales amount for the goods or services it has provided.

Thereafter, whenever an event of the purchase price payment statement management or an event of requesting the sales amount prepayment occurs from the purchaser company's telecommunication client (1) or the seller company's telecommunication client (2), the payment management server (10) coordinates the said authentication module (30), the purchase price payment statement management module (40), the prepayment collection management module (50), the operational information management module (60) and the account management module (90) so that the steps for the purchase price payment statement management or the steps for the sales amount prepayment management may be systematically conducted. Resultantly, the purchaser company and the seller companies may establish a reliable settlement relationship based upon the bank on-line network

As explained above in detail, the present invention enables a purchaser company to establish settlement relationships with seller companies without incurring special financial strains, by making on-line prepayments of the purchase price on behalf of the purchaser company based upon the rights to the accounts receivable that the seller company had obtained from the purchaser company and provided as a collateral.

The present invention also precludes the purchaser company from using the conventional payment method by bills and, thus, may improve the reliability of the settlement system formed between the purchaser company and the seller companies. Consequently, unexpected damage or loss to the seller companies may be minimized.

Moreover, the present invention may implement the overall settlement procedures conducted between seller companies and purchaser companies systematically on the on-line networks. Through such implementation of the system on the on-line networks, it is intended that the seller companies and the purchaser company may conveniently conduct the sales amount collection procedure and the purchase price payment procedure without bearing unnecessary risks of theft or loss.

Furthermore, the present invention improves the reliability of the settlement system between the purchaser company and the seller companies, minimizing the economic loss caused by various companies' chain bankruptcy.

Preferred embodiments of the present invention have been specifically explained and illustrated in the above. However, it is apparent to persons skilled in the relevant art that the present invention may be modified in various manners and implemented accordingly.

Such modified implements must not be understood separately from the present invention in terms of the technology involved and must be deemed included in the extent of claims of the present invention attached hereto.

What is claimed is:

1. An inter-company settlement management system comprising:
a D/B block equipped with an authentication information database (“D/B”) containing authentication information, a purchase price payment statement information D/B containing purchase price payment statement information, a loan prepayment information D/B containing loan prepayment information, a credit card purchase price prepayment information D/B containing information on the purchase price prepayment by credit card, and a registration information D/B containing registration information about the relevant purchaser companies and seller companies;
a D/B management server which stores the said authentication information, purchase price payment statement information, loan prepayment information, credit card purchase price prepayment information or registration information selectively in the relevant field of the said D/B block, or extracts the relevant information from the said D/B block;
a payment management server which: in a state connected to the said D/B management server for telecommunication, determines whether to store or extract the said authentication information, purchase price payment statement information, loan prepayment information, credit card purchase price prepayment information, and registration information about the relevant purchaser companies and seller companies; interfaces with the telecommunication clients of the purchaser company and the seller companies through the bank on-line network; and if an event for management of the purchase price payment statement and an event of requesting the purchase price prepayment arises in telecommunication clients of a purchaser company and a seller company, analyzes the said authentication information, purchase price payment statement information, loan prepayment information, credit card purchaser price prepayment information, registration information about the purchaser company and the seller company, prepays the purchase price that the relevant purchaser company must pay to the seller company, and collects, on line, the amount equivalent to the said prepaid amount from the purchaser company after a predetermined period of time passes.

2. The inter-company settlement management system according to claim 1, wherein the said bank on-line network is any network among the Internet, an automatic response system communication network, a value added network or a public switched telephone network.

3. The inter-company settlement management system according to claim 1, wherein the said payment management server further forms a telecommunication relationship with the purchase price payment statement management module which is exclusively responsible for managing the purchase price payment statements transmitted from the said purchaser company's telecommunication client.

4. The inter-company settlement management system according to claim 1, wherein the said payment management server further forms a telecommunication relationship with the prepayment collection management module which is exclusively responsible for managing the prepaid amount to be collected from the said purchaser company.

5. The inter-company settlement management system according to claim 1, wherein the said payment management server further forms a telecommunication relationship with the account management module which is exclusively responsible for managing the designated accounts of the said purchaser companies and the said seller companies.

6. An inter-company settlement management method comprising the steps of:
determining whether a system access event has occurred from either a purchaser company's telecommunication client or a seller company's telecommunication client;
in the event that a system access event has occurred from either a purchaser company's telecommunication client or a seller company's telecommunication client, determining, through the connected client, whether the connected company is a registered company;
in the event that the said connected company is determined to be a registered company, determining whether the said registered company is a purchaser company;
in the event that the said registered company is determined to be a purchaser company, generating an initial page for a purchaser company and transmitting the completed initial page for a purchaser company to the telecommunication client of the said purchaser company;
determining whether an event for managing the purchase price payment statement has occurred from the said purchaser company's telecommunication client; and,
in the event that an event for managing the purchaser price payment statement has occurred from the said purchaser company's telecommunication client, referring to the purchase price payment statement information transmitted from the said purchaser company's telecommunication client and conducting a series of steps for managing the purchaser price payment statement.

7. The inter-company settlement management method according to claim 6, wherein the said steps for managing the purchase price payment statement comprise the steps of:
determining whether an event of the account receivable statement transmission has occurred from the telecommunication client of the said purchaser company;
in the event that an event of the account receivable statement transmission has occurred from the said telecommunication client of the purchaser company, transmitting to the said purchaser company's telecommunication client an account receivable information input message for the inputting of the details regarding the relevant accounts receivable;
determining whether the account receivable information corresponding to the said account receivable information input message has been transmitted from the said purchaser company's telecommunication client;
in the event that the account receivable information corresponding to the said account receivable information input message has been transmitted from the said purchaser company's telecommunication client, determining whether the inputted information regarding the account receivable statement is acceptable; and, in the event that the said inputted account receivable information is determined to be acceptable, collecting and storing the account receivable statement information transmitted from the said purchaser company's telecommunication client.

8. The inter-company settlement management method according to claim 7, further comprising the steps of:
in the event that the said event is not for the account receivable statement transmission, transmitting to the said purchaser company's telecommunication client a credit card purchase statement input message for the inputting of the details regarding the said purchaser company's credit card purchase;
determining whether the credit card purchase information corresponding to the said credit card purchase statement input message has been transmitted from the said purchaser company's telecommunication client;
in the event that the credit card purchase information corresponding to the said credit card purchase statement input message has been transmitted from the said purchaser company's telecommunication client, determining whether the inputted information regarding the credit card purchase is acceptable; and,
in the event that the said inputted credit card purchase information is determined to be acceptable, collecting and storing the credit card purchase statement information transmitted from the said purchaser company's telecommunication client.

9. The inter-company settlement management method according to claim 6, further comprising the steps of:
in the event that the relevant company is determined to be a seller company, generating an initial page for a seller company and transmitting the completed initial page for a seller company to the telecommunication client of the said seller company;
determining whether an event of requesting the sales amount prepayment has occurred from the said seller company's telecommunication client; and,
in the event that an event of requesting the sales prepayment has occurred from the said seller company's telecommunication client, referring to the sales amount prepayment request information transmitted from the said seller company's telecommunication client and conducting a series of steps for the sales amount prepayment.

10. The inter-company settlement management method according to claim 9, wherein the said steps for the sales amount prepayment comprise the steps of:
determining whether an event of the loan request based upon the account receivable statement has occurred from the telecommunication client of the said seller company;
in the event that an event of the loan request based upon the account receivable statement has occurred from the said telecommunication client of the seller company, transmitting to the said seller company's telecommunication client a loan request information input message for the inputting of the details regarding the loan request;
determining whether the loan request information corresponding to the said loan request information input message has been transmitted from the said seller company's telecommunication client;
in the event that the loan request information corresponding to the said loan request information input message has been transmitted from the said seller company's telecommunication client, determining whether the requested loan amount recorded in the said loan request information does not exceed the predetermined credit balance amount; and,
in the event that the said requested loan amount recorded in the said loan request information does not exceed the predetermined credit balance amount, conducting a series of steps to make the prepayment of the said requested loan amount.

11. The inter-company settlement management method according to claim 10, further comprising the steps of:
in the event that the said event is not for the loan request, transmitting to the said seller company's telecommunication client a credit card sales statement input message for the inputting of the details regarding the said seller company's credit card sales;
determining whether the credit card sales information corresponding to the said credit card sales statement input message has been transmitted from the said seller company's telecommunication client;
in the event that the credit card sales information corresponding to the said credit card sales statement input message has been transmitted from the said seller company's telecommunication client, determining whether the credit card sales amount recorded in the said credit card sales information does not exceed the predetermined credit balance amount; and,
in the event that the credit card sales amount recorded in the said credit card sales information does not exceed the predetermined credit balance amount, conducting a series of steps to make the prepayment of the requested credit card sales amount.

12. The inter-company settlement management system according to claim 6, after conducting the said steps for managing the purchaser price payment statement, further comprising the steps of:
determining whether there is any item among the purchase price payment statement that is due on the present day; and
in the event that there is an item among the purchase price payment statement that is due on the present day, checking the designated account of the purchaser company which issued the said due purchase price payment statement and conducting a series of steps for managing the purchase price settlement.

13. The inter-company settlement management system according to claim 12, wherein the said steps for managing the purchase price settlement comprise the steps of:
determining whether the said item that is due on the present day is subject to the prepayment collection;
in the event that the said due item is subject to the prepayment collection, determining whether the said item subject to the prepayment collection is an item subject to the collection of the loan prepayment based upon the account receivable statement;
in the event that the said due item is subject to the collection of the loan prepayment based upon the account receivable statement, determining whether the amount deposited in the said purchaser company's designated account is not less than the amount of the loan prepayment; and
in the event that the amount deposited in the said purchaser company's designated account is not less than the amount of the loan prepayment, collecting the said amount of the loan prepayment from the amount deposited in the said purchaser company's designated account and depositing in the seller company's designated account the relevant balance amount of the purchase price after the deduction of the said amount of the loan prepayment.

14. The inter-company settlement management method according to claim 13, further comprising the step of declaring the said seller company in default in the event that the amount deposited in the said purchaser company's designated account is less than the said amount of the loan prepayment.

15. The inter-company settlement management method according to claim 13, further comprising the steps of:
in the event that the said item subject to the prepayment collection is not an item subject to the recollection of the loan prepayment based upon the account receivable statement, determining whether the amount deposited in the said purchaser company's designated account is not less than the amount of the credit card purchase price prepayment;
in the event that the said amount deposited in the said purchaser company's designated account is not less than the amount of the credit card purchase price prepayment, collecting the said amount of the credit card purchase price prepayment from the amount deposited in the said purchaser company's designated account and depositing the relevant balance amount of the purchase price after the deduction of the amount of the said credit card purchase price prepayment in the seller company's designated account.

16. The inter-company settlement management method according to claim 15, further comprising the step of declaring the said purchaser company in default in the event that the amount deposited in the said purchaser company's designated account is less than the amount of the said credit card purchase price prepayment.
